(19) United States
(12) Patent Application Publication
(10) Pub. No.: US 2024/0362324 A1
(43) Pub. Date: Oct. 31, 2024

(54) RISK BASED ALERTING AND ENTITY PRIORITIZATION DETECTION FRAMEWORK

(71) Applicant: Snowflake Inc., Bozeman, MT (US)

(72) Inventors: Kyle Joseph Derevyanik, Austin, TX (US); Haider Dost, Fairfax, VA (US); Tammy T. Truong, Concord, CA (US)

(21) Appl. No.: 18/309,693

(22) Filed: Apr. 28, 2023

(51) Int. Cl. G06F 21/55

(52) U.S. Cl. CPC G06F 21/554; G06F 2221/034

(57) ABSTRACT

A computer-implemented method includes accessing, by one or more processors of an alerting system, security event data generated by one or more computing devices, computing, by the one or more processors, an identity prioritization score by applying an identity prioritization algorithm to the security event data, computing, by the one or more processors, an asset prioritization score by applying an asset prioritization algorithm applied to the security event data, determining, by the one or more processors, a detection likelihood score of one or more security activities identified in the security event data, by applying a detection likelihood algorithm to the security event data, and computing, by the one or more processors, a risk score of the one or more security activities by applying a risk-based algorithm that is based on the identity prioritization score, the asset prioritization score, and the detection likelihood score of the one or more security activities.

### TECHNICAL FIELD

The present disclosure generally relates to special-purpose machines that identify threats to computer systems, and to the technologies by which such special-purpose machines become improved compared to other special-purpose machines for assessing risks.

### BACKGROUND

Entity driven detection such as Risk based alerting (RBA) is a detection security solution that monitors security events and searches for known threats and suspicious or malicious activity. The RBA system sends alerts to information technology (IT) and security teams when it detects any security risks and threats based on predefined risk scores and thresholds. However, traditional detection systems such as SIEM (security information and event management) operate on an atomic basis. For example, each triggered detection results in an additional case for the IT and security teams to triage.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example computing environment that includes a network-based database system in communication with a cloud storage provider system, in accordance with some embodiments of the present disclosure.

FIG. 2 is a block diagram illustrating components of a database service manager, in accordance with some embodiments of the present disclosure.

FIG. 3 is a block diagram illustrating components of an execution platform, in accordance with some embodiments of the present disclosure.

FIG. 4 is a block diagram illustrating storage of database tables in micro-partitions, according to some example embodiments.

FIG. 5 is a block diagram illustrating an alerting system in accordance with one example embodiment.

FIG. 6 is a block diagram illustrating an asset and identity prioritization component in accordance with one example embodiment.

FIG. 7 is a block diagram illustrating a detection likelihood component in accordance with one example embodiment.

FIG. 8 is a block diagram illustrating a risk-based alerting component in accordance with one embodiment.

FIG. 9 is a process diagram illustrating an identity prioritization process in accordance with one example embodiment.

FIG. 10 is a process diagram illustrating an asset prioritization process in accordance with one example embodiment.

FIG. 11 is a process diagram illustrating a detection likelihood process in accordance with one example embodiment.

FIG. 12 is a process diagram illustrating a risk-based alerting process in accordance with one example embodiment.

FIG. 13 is a flow diagram illustrating a method for computing an aggregate risk score in accordance with one example embodiment.

FIG. 14 illustrates a routine 1400 in accordance with one example embodiment.

FIG. 15 is an alerting graphical user interface in accordance with one example embodiment.

FIG. 16 is block diagram showing a software architecture within which the present disclosure may be implemented, according to an example embodiment,

FIG. 17 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Databases are widely used for data storage and access in computing applications. Databases may include one or more tables that include or reference data that can be read, modified, or deleted using queries. Querying very large databases and/or tables might require scanning large amounts of data. Reducing the amount of data scanned is one of the main challenges of data organization and processing.

The term “micro-partition” is used herein to refer to a contiguous unit of storage that stores some or all of the data of a single table. In some example embodiments, each micro-partition stores between 50 and 500 MB of uncompressed data. Micro-partitions may be stored in a compressed or uncompressed form. Groups of rows in tables may be mapped into individual micro-partitions organized in a columnar fashion. In relational databases comprising rows and columns, all columns for the rows of a micro-partition are stored in the micro-partition. Some large tables are stored in millions or hundreds of millions of micro-partitions. The set of micro-partitions to scan in executing a query may be referred to herein as a “scan set.”

In some example embodiments, a micro-partition is a file in a file system. Metadata may be automatically gathered about all rows stored in a micro-partition, including: the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded. However, it should be appreciated that this disclosure of the micro-partition is exemplary only and should be considered non-limiting. It should be appreciated that the micro-partition may include other database storage devices without departing from the scope of the disclosure.

The present application describes an RBA system that aggregates security events, and creates an alert narrative based on quantitative reasoning. RBA takes the aggregated security events, adds up the cumulative risk, and triggers an alert when the cumulative risk score surpasses a preset threshold. This can be done over several different time periods, including, but not limited to, 24 hours, seven days, or one month.

The present application also describes an Asset and Identity Prioritization (AIP) that provides two deliverables. The first deliverable is the prioritization of identities and assets in the environment, which is used dynamically to enhance alerting capabilities. The second deliverable centralizes asset and identity management to track known and unknown entities. This data augments alerting data and allows Security Operation Centers (SOC) and Incident Response (IR) to respond in an efficient manner. The term SOC refers to a centralized function or team that monitors and analyzes an organization's IT infrastructure and security posture 24/7 to detect and respond to cyberattacks. The term IR refers to a group of experts who are responsible for responding to an information security incident, such as a data breach or ransomware attack.

The present application describes a system that combines risk based alerting (RBA), asset and identity prioritization (AIP), and detection likelihood framework. The system provides an improved detection strategy and an alert engine to detect malicious activities. The detection strategy utilizes entity prioritization scores and risk aggregation to create alert narratives for SOC and/or IR. In one example, the system is based on an entity (identity and asset) management framework, an entity prioritization algorithm (identity prioritization, asset prioritization), detection likelihood algorithm, and risk-based alerting.

Example advantages of the presently-described system include:
Reduce alert fatigue: converting noisy atomic/one to one alerts to a sequence of observable events.
Increase alert fidelity and alert correlation: including alert context for entities over a period of time increases true positives for detecting malicious activity (in one example, the presently described system can connect with disparate events from non-RBA systems).
Prioritize the alert queue: risk aggregation allows IR to look at cases which have the highest quantitative risk based on the entity first.

In one example, a computer-implemented method includes accessing, by one or more processors of an alerting system, security event data generated by one or more computing devices, computing, by the one or more processors, an identity prioritization score by applying an identity prioritization algorithm to the security event data, computing, by the one or more processors, an asset prioritization score by applying an asset prioritization algorithm applied to the security event data, determining, by the one or more processors, a detection likelihood score of one or more security activities identified in the security event data, by applying a detection likelihood algorithm to the security event data, and computing, by the one or more processors, a risk score of the one or more security activities by applying a risk-based algorithm that is based on the identity prioritization score, the asset prioritization score, and the detection likelihood score of the one or more security activities.

The security event data includes all types of communication to and from one or more computing devices. For example, the security event data include, but is not limited to, flow logs, API logs, and web logs. In another example, the alerting system accesses network traffic data that identifies a combination of source IP addresses, destination IP addresses, ports, protocols, payloads, timestamps, and intervals. In another example, the security event data is based on the network traffic data and includes some of the network traffic data.

As a result, one or more of the methodologies described herein facilitate solving the technical problem of detecting and identifying threats based on risk and entity prioritization. As such, one or more of the methodologies described herein may obviate a need for certain efforts or computing resources that otherwise would be involved in monitoring and auditing network traffic and cloud activity on an atomic level. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

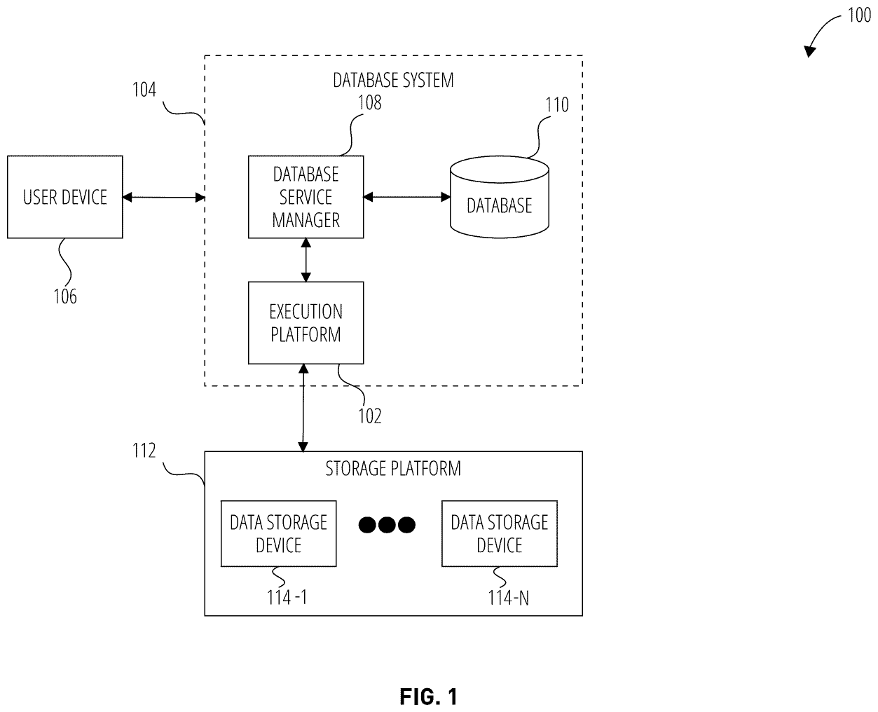

FIG. 1 illustrates an example computing environment 100 that includes a database system 104 in communication with a storage platform 112, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the computing environment 100 comprises the database system 104 and a storage platform 112 (e.g., AWS®, Microsoft Azure Blob Storage®, or Google Cloud Storage®). The database system 104 is used for reporting and analysis of integrated data from one or more disparate sources including data storage device 114-1 to data storage device 114-N within the storage platform 112. The storage platform 112 comprises a plurality of computing machines and provides on-demand computer system resources such as data storage and computing power to the database system 104.

The database system 104 comprises a database service manager 108, an execution platform 102, and a database 110. The database system 104 hosts and provides data reporting and analysis services to multiple client accounts. Administrative users can create and manage identities (e.g., users, roles, and groups) and use permissions to allow or deny access to the identities to resources and services.

The database service manager 108 coordinates and manages operations of the database system 104. The database service manager 108 also performs query optimization and compilation as well as managing clusters of compute services that provide compute resources (also referred to as “virtual warehouses”). The database service manager 108 can support any number of client accounts such as end users providing data storage and retrieval requests, system administrators managing the systems and methods described herein, and other components/devices that interact with the database service manager 108.

The database service manager 108 is also in communication with a user device 106. The user device 106 corresponds to a user of one of the multiple client accounts supported by the database system 104. In some embodiments, the database service manager 108 does not receive any direct communications from the user device 106 and only receives communications concerning jobs from a queue within the database system 104.

The database service manager 108 is also coupled to database 110, which is associated with the data stored in the computing environment 100. The database 110 stores data pertaining to various functions and aspects associated with the database system 104 and its users. In some embodiments, the database 110 includes a summary of data stored in remote data storage systems as well as data available from a local cache. Additionally, the database 110 may include information regarding how data is organized in remote data storage systems (e.g., storage platform 112) and the local caches. The database 110 allows systems and services to determine whether a piece of data needs to be accessed without loading or accessing the actual data from a storage device.

In some embodiments, the database service manager 108 may determine that a job should be performed based on data from the database 110. In such embodiments, the database service manager 108 may scan the data and determine that a job should be performed to improve data organization or database performance.

The database service manager 108 is further coupled to the execution platform 102, which provides multiple computing resources that execute various data storage and data retrieval tasks. The execution platform 102 is coupled to the storage platform 112. The storage platform 112 comprises multiple data storage devices 114-1 to 114-N. In some embodiments, the data storage devices 114-1 to 114-N are cloud-based storage devices located in one or more geographic locations. For example, the data storage devices 114-1 to 114-N may be part of a public cloud infrastructure or a private cloud infrastructure. The data storage devices 114-1 to 114-N may be hard disk drives (HDDs), solid state drives (SSDs), storage clusters, Amazon S3™ storage systems or any other data storage technology. Additionally, the storage platform 112 may include distributed file systems (e.g., Hadoop Distributed File Systems (HDFS)), object storage systems, and the like.

The execution platform 102 comprises a plurality of compute nodes. A set of processes on a compute node executes a query plan compiled by the database service manager 108. The set of processes can include: a first process to execute the query plan; a second process to monitor and delete micro-partition files using a least recently used (LRU) policy and implement an out of memory (OOM) error mitigation process; a third process that extracts health information from process logs and status to send back to the database service manager 108; a fourth process to establish communication with the database service manager 108 after a system boot; and a fifth process to handle all communication with a compute cluster for a given job provided by the database service manager 108 and to communicate information back to the database service manager 108 and other compute nodes of the execution platform 102.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 1, the data storage devices 114-1 to 114-N are decoupled from the computing resources associated with the execution platform 102. This architecture supports dynamic changes to the database system 104 based on the changing data storage/retrieval needs as well as the changing needs of the users and systems. The support of dynamic changes allows the database system 104 to scale quickly in response to changing demands on the systems and components within the database system 104. The decoupling of the computing resources from the data storage devices 114-1 to 114-N supports the storage of large amounts of data without requiring a corresponding large amount of computing resources. Similarly, this decoupling of resources supports a significant increase in the computing resources utilized at a particular time without requiring a corresponding increase in the available data storage resources.

The database service manager 108, the database 110, the execution platform 102, and the storage platform 112 are shown in FIG. 1 as individual discrete components. However, each of the database service manager 108, the database 110, the execution platform 102, and the storage platform 112 may be implemented as a distributed system (e.g., distributed across multiple systems/platforms at multiple geographic locations). Additionally, each of the database service manager 108, the database 110, the execution platform 102, and the storage platform 112 can be scaled up or down (independently of one another) depending on changes to the requests received and the changing needs of the database system 104. Thus, in the described embodiments, the database system 104 is dynamic and supports regular changes to meet the current data processing needs.

During typical operation, the database system 104 processes multiple jobs determined by the database service manager 108. These jobs are scheduled and managed by the database service manager 108 to determine when and how to execute the job. For example, the database service manager 108 may divide the job into multiple discrete tasks and may determine what data is needed to execute each of the multiple discrete tasks. The database service manager 108 may assign each of the multiple discrete tasks to one or more nodes of the execution platform 102 to process the task. The database service manager 108 may determine what data is needed to process a task and further determine which nodes within the execution platform 102 are best suited to process the task. Some nodes may have already cached the data needed to process the task and, therefore, be a good candidate for processing the task.

Metadata stored in the database 110 assists the database service manager 108 in optimizing user queries by determining which nodes in the execution platform 102 have already cached at least a portion of the data needed to process the task. In some embodiments, metadata includes a summary of data stored in remote data storage systems as well as data available from a local cache (e.g., a cache within one or more of the clusters of the execution platform 102). Additionally, metadata may include information regarding how data is organized in the remote data storage systems and the local caches. Metadata allows systems and services to determine whether a piece of data needs to be processed without loading or accessing the actual data from a storage device.

One or more nodes in the execution platform 102 process the task using data cached by the nodes and, if necessary, data retrieved from the storage platform 112. It is desirable to retrieve as much data as possible from caches within the execution platform 102 because the retrieval speed is typically much faster than retrieving data from the storage platform 112.

As shown in FIG. 1, the computing environment 100 separates the execution platform 102 from the storage platform 112. In this arrangement, the processing resources and cache resources in the execution platform 102 operate independently of the data storage devices 114-1 to 114-N in the storage platform 112. Thus, the computing resources and cache resources are not restricted to specific data storage devices 114-1 to 114-N. Instead, all computing resources and all cache resources may retrieve data from, and store data to, any of the data storage resources in the storage platform 112.

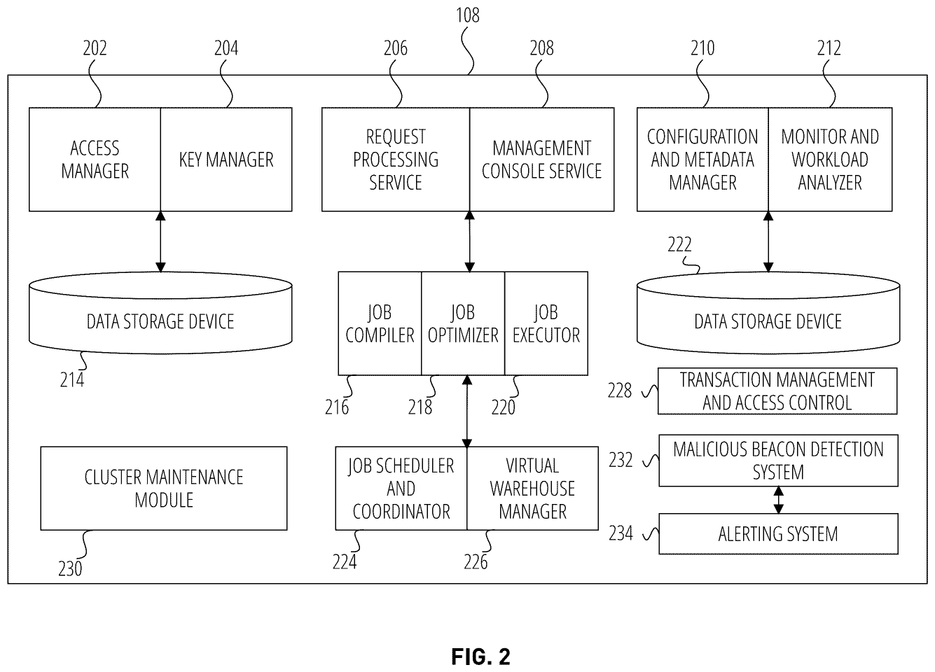

FIG. 2 is a block diagram illustrating components of the database service manager 108, in accordance with some embodiments of the present disclosure. As shown in FIG. 2, the database service manager 108 includes an access manager 202, a key manager 204, a request processing service 206, a management console service 208, a configuration and metadata manager 210, a monitor and workload analyzer 212, a data storage device 214, a job compiler 216, a job optimizer 218, a job executor 220, a data storage device 222, a job scheduler and coordinator 224, a virtual warehouse manager 226, a transaction management and access control 228, and a cluster maintenance module 230.

The access manager 202 and the key manager 204 coupled to the data storage device 214. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices 114-1 to 114-N in storage platform 112). As used herein, the remote storage devices may also be referred to as “persistent storage devices” or “shared storage devices.”

The request processing service 206 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 102 or in a data storage device in storage platform 112.

The management console service 208 supports access to various systems and processes by administrators and other system managers. Additionally, the management console service 210 may receive a request to execute a job and monitor the workload on the system.

The job compiler 216 parses a job into multiple discrete tasks and generates the execution code for each of the multiple discrete tasks. The job optimizer 218 determines the best method to execute the multiple discrete tasks based on the data that needs to be processed. The job optimizer 218 also handles various data pruning operations and other data optimization techniques to improve the speed and efficiency of executing the job. The job executor 220 executes the execution code for jobs received from a queue or determined by the database service manager 108.

The job scheduler and coordinator 224 sends received jobs to the appropriate services or systems for compilation, optimization, and dispatch to the execution platform 102. For example, jobs may be prioritized and processed in that prioritized order. In an embodiment, the job scheduler and coordinator 224 determines a priority for internal jobs that are scheduled by the database service manager 108 with other “outside” jobs such as user queries that may be scheduled by other systems in the database but may utilize the same processing resources in the execution platform 102. In some embodiments, the job scheduler and coordinator 224 identifies or assigns particular nodes in the execution platform 102 to process particular tasks.

The virtual warehouse manager 226 manages the operation of multiple virtual warehouses implemented in the execution platform 102. As discussed below, each virtual warehouse includes multiple execution nodes that each include a cache and a processor.

The configuration and metadata manager 210 manages the information related to the data stored in the remote data storage devices and in the local caches (e.g., the caches in execution platform 102). In one example, the configuration and metadata manager 210 uses the metadata to determine which data micro-partitions need to be accessed to retrieve data for processing a particular task or job.

The monitor and workload analyzer 212 oversees processes performed by the database service manager 108 and manages the distribution of tasks (e.g., workload) across the virtual warehouses and execution nodes in the execution platform 102. The monitor and workload analyzer 212 also redistributes tasks, as needed, based on changing workloads throughout the database system 104 and may further redistribute tasks based on a user (e.g., “external”) query workload that may also be processed by the execution platform 102. The configuration and metadata manager 210 and monitor and workload analyzer 212 are coupled to the data storage device 222. The data storage device 222 and the data storage device 214 represent any data storage device within the database system 104. For example, data storage device 222 and the data storage device 214 may represent caches in execution platform 102, storage devices in storage platform 112, or any other storage device.

The transaction management and access control 228 manages the various tasks and other activities associated with the processing of data storage requests and data access requests. For example, the transaction management and access control 228 provides consistent and synchronized access to data by multiple users or systems. Since multiple users/systems may access the same data simultaneously, changes to the data may be synchronized to ensure that each user/system is working with the current version of the data. The transaction management and access control 228 provides control of various data processing activities at a single, centralized location in database service manager 108.

The cluster maintenance module 230 manages the clustering and ordering of partitions of a table. The cluster maintenance module 230 may partition each table in a database into one or more partitions or micro-partitions. The cluster maintenance module 230 may not require or achieve ideal clustering for the table data but may maintain “good enough” or approximate clustering. For example, ideal clustering on a specific attribute may result in each partition either having non-overlapping value ranges or having only a single value for the specific attribute. Because the cluster maintenance module 230 does not require perfect clustering, significant processing and memory resources may be conserved during data loading or DML command operations.

At least some embodiments may manage the ordering or clustering of a table using micro-partitions. As mentioned previously, traditional data warehouses rely on static partitioning of large tables to achieve acceptable performance and enable better scaling. In these systems, a partition is a unit of management that is manipulated independently using specialized data definition language (DDL) and syntax. However, static partitioning has a number of well-known limitations, such as maintenance overhead and data skew, which can result in disproportionately-sized partitions. Embodiments disclosed herein may implement a powerful and unique form of partitioning, called micro-partitioning, that delivers all the advantages of static partitioning without the known limitations, as well as providing additional significant benefits.

In one embodiment, all data in tables is automatically divided into micro-partitions, which are contiguous units of storage. By way of example, each micro-partition may contain between 50 MB and 500 MB of uncompressed data (note that the actual size in storage may be smaller because data may be stored compressed). Groups of rows in tables are mapped into individual micro-partitions, organized in a columnar fashion. This size and structure allows for extremely granular pruning of very large tables, which can be comprised of millions, or even hundreds of millions, of micro-partitions. Metadata may be automatically gathered about all rows stored in a micro-partition, including: the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded.

The malicious beacon detection system 232 accesses VPC data flow logs and detects malicious beacon activities (e.g., by using a trained unsupervised machine learning model). The machine learning model is trained based on features extracted from the VPC data flow logs. The malicious beacon detection system 232 communicates alert data to the alerting system 234.

The alerting system 234 uses a combination of RBA, AIP, and detection likelihood, to process the alert data, the security event data, and network communication data to and from the database system 104 (or to and from other database systems). The alerting system 234 generates a risk score associated with each detection (e.g., security event) that triggers for a specific entity.

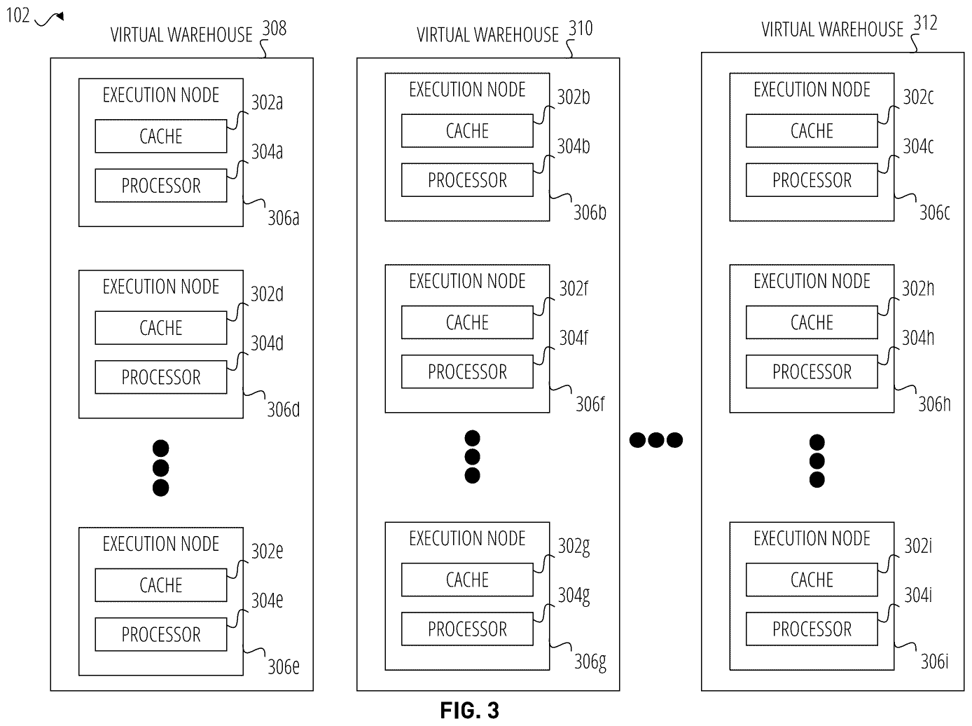

FIG. 3 is a block diagram illustrating components of the execution platform 102, in accordance with some embodiments of the present disclosure. As shown in FIG. 3, the execution platform 102 includes multiple virtual warehouses, including virtual warehouse 308, virtual warehouse 310, virtual warehouse 312. Each virtual warehouse includes multiple execution nodes that each includes a data cache and a processor. The virtual warehouses can execute multiple tasks in parallel by using the multiple execution nodes. As discussed herein, the execution platform 102 can add new virtual warehouses and drop existing virtual warehouses in real-time based on the current processing needs of the systems and users. This flexibility allows the execution platform 102 to quickly deploy large amounts of computing resources when needed without being forced to continue paying for those computing resources when they are no longer needed. All virtual warehouses can access data from any data storage device (e.g., any storage device in storage platform 112).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 114-1 to 114-N shown in FIG. 1. Thus, the virtual warehouses are not necessarily assigned to a specific data storage devices 114-1 to 114-N and, instead, can access data from any of the data storage devices 114-1 to 114-N within the storage platform 104. Similarly, each of the execution nodes shown in FIG. 3 can access data from any of the data storage devices 114-1 to 114-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 308 includes three execution nodes (execution node 306a, 306d, 306e). The execution node 306a includes a cache 302a and a processor 304a. Execution node 306d includes a cache 302d and a processor 304d. Execution node 306e includes a cache 302e and a processor 304e.

Each execution node 306a, 306d, 306e is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 308 discussed above, virtual warehouse 310 includes three execution nodes (execution node 306b, 306f, 306g). Execution node 306b includes a cache 302b and a processor 304b. Execution node 306f includes a cache 302f and a processor 304f. Execution node 306g includes a cache 302g and a processor 304g.

Similar to virtual warehouse 308 and virtual warehouse 310 discussed above, virtual warehouse 312 includes three execution nodes (execution node 306c, 306h, 306i). Execution node 306c includes a cache 302c and a processor 304c. Execution node 306f includes a cache 302f and a processor 304f. Execution node 306g includes a cache 302g and a processor 304g.

In some embodiments, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 112. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 112.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 308, 310, and 312 are associated with the same execution platform 102, the virtual warehouses may be implemented using multiple computing systems at multiple geographic locations. For example, virtual warehouse 308 can be implemented by a computing system at a first geographic location, while virtual warehouse 310 and virtual warehouse 312 are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 308 implements execution node 306a and 306d on one computing platform at a geographic location and implements execution node 306e at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 102 is also fault tolerant. For example, if one virtual warehouse fails, that virtual warehouse is quickly replaced with a different virtual warehouse at a different geographic location.

A particular execution platform 102 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in storage platform 112, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

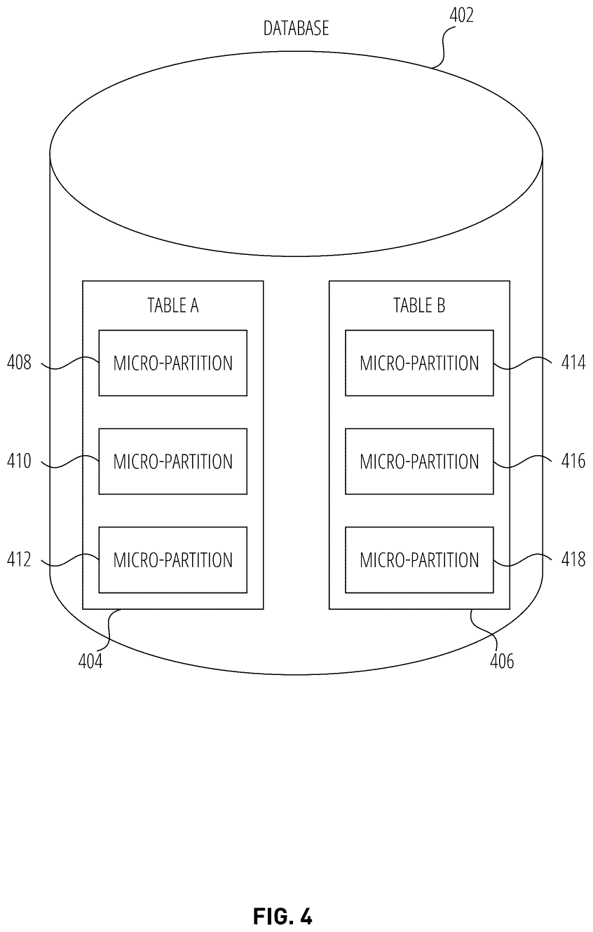

FIG. 4 is a block diagram of a database 402 illustrating storage of database tables in micro-partitions, according to some example embodiments. The database 402 includes table A 404 and table B 406. The table A 404 is stored in micro-partitions 408, 410, and 412. The table B 406 is stored in micro-partitions 414, 416, and 418. Each micro-partition may be implemented as a file in a file system.

Each of the micro-partitions 408-418 may be compressed or uncompressed. Furthermore, each of the compressed micro-partitions may be compressed using a different compression algorithm. Thus, the micro-partition 408 may have a first column stored using dictionary compression, the micro-partition 410 may be stored uncompressed, and the micro-partition 412 may store a second column using dictionary compression. Similarly, the micro-partition 414 may have a first column stored using dictionary compression, the micro-partition 416 may have the first column and a second column stored using dictionary compression, and the micro-partition 418 may be stored using run-length encoding for the same or different columns.

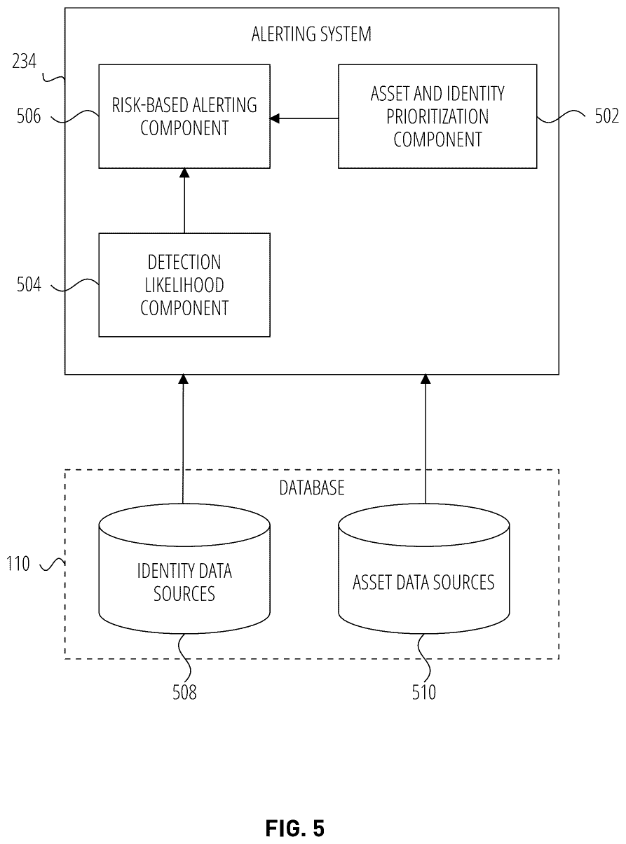

FIG. 5 is a block diagram illustrating the alerting system 234 in accordance with one example embodiment. The alerting system 234 includes a risk-based alerting component 506, an asset and identity prioritization component 502, and a detection likelihood component 504. The database 110 stores, for example, identity data sources 508 and asset data sources 510.

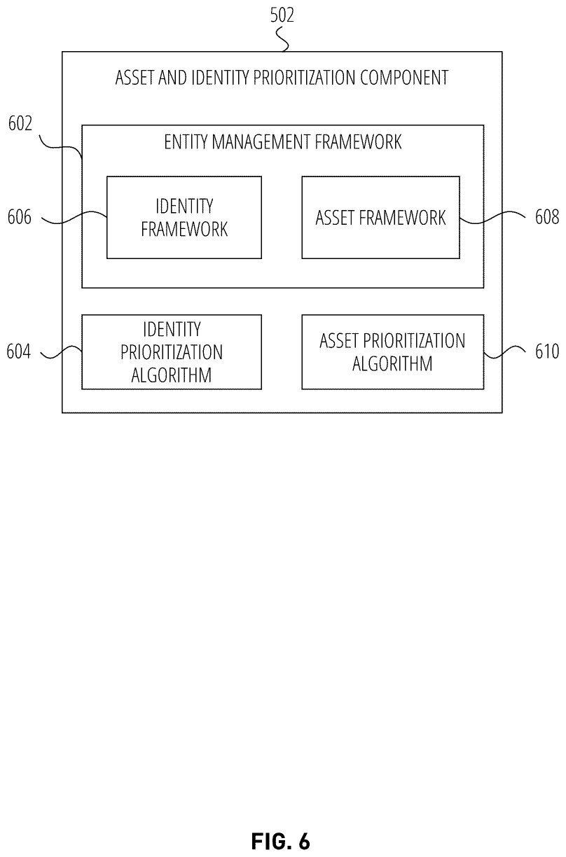

The asset and identity prioritization component 502 provides an entity management framework. Every detection is associated with an endpoint, user, service, application or mechanism of the database system 104. As such, the asset and identity prioritization component 502 has access to a record of these assets. The asset and identity prioritization component 502 is described in more detail below with respect to FIG. 6.

The detection likelihood component 504 provides a detection likelihood framework. Previously all threat detections have a severity, which helps the SOC and/or IR team prioritize triaging and working on security alerts. However, detection severity typically uses an impact versus likelihood matrix that can be inconsistent across individuals. In contrast, the detection likelihood component 504 provides a framework for an objective and standardized way to dynamically prioritize alerts from risk, impact, and likelihood. Detection likelihood uses the entity prioritization scores to measure impact and a likelihood score to measure likelihood, to ultimately create a dynamic detection severity.

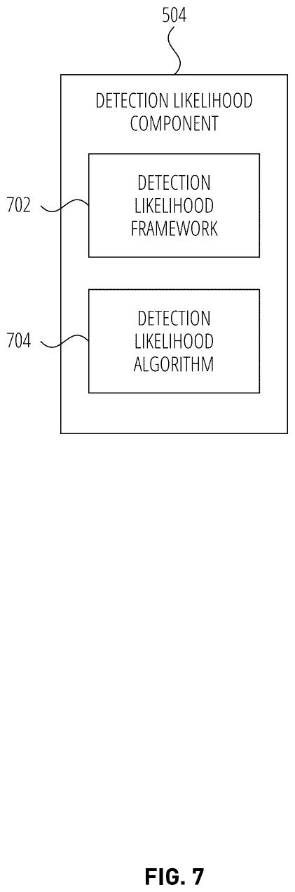

With the implementation of the presently-described RBA system, the entity risk and detection likelihood are both evaluated to determine the overall alert risk score. A custom detection likelihood framework and algorithm provide an objective and standardized way to determine detection likelihood and ultimately assign more accurate alert risk scores. The detection likelihood component 504 is described in more detail below with respect to FIG. 7.

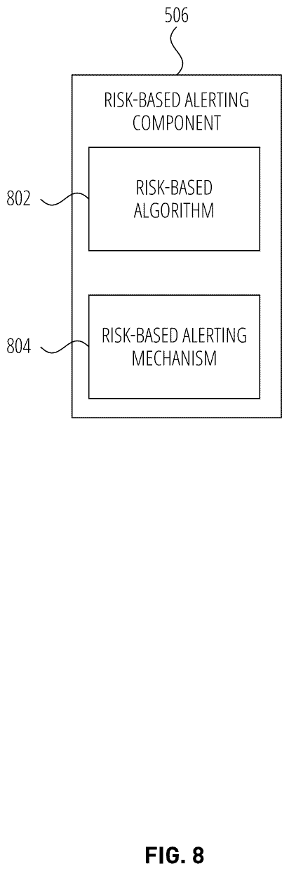

The risk-based alerting component 506 computes a risk score based on results from the asset and identity prioritization component 502 and the detection likelihood component 504. The risk-based alerting component 506 is described in more detail below with respect to FIG. 8.

FIG. 6 is a block diagram illustrating the asset and identity prioritization component 502 in accordance with one example embodiment. The asset and identity prioritization component 502 includes an entity management framework 602, an identity prioritization algorithm 604, and an asset prioritization algorithm 610.

The entity management framework 602 serves as two centralized tables (e.g., one for identities and one for assets) that bear the source of truth for detections and prioritization of those assets. The entity management framework 602 contains aliases, peripheral accounts, known identifiers, known services runnings, vulnerabilities associated, and contact information aggregated back to a single “asset.” The entity management framework 602 takes into account both known and unknown entities in the environment.

In one example, the entity management framework 602 includes an identity framework 606 and an asset framework 608. The identity framework 606 holds information related to the various identities in the environment and can be formed from several sources of truth. Identities can be users, services, or even roles performing actions. In one example, the identity framework 606 assumes complete compromise in order to aggregate identities. This means that despite accounts sitting behind different SSO (single sign on) IDs, the identity is tied together based on a single common identifier such as an email. For example, a user that has a first and a second account will only have one identity (e.g., aggregated in a common identifier).

The following illustrates an example of a skeleton of an identity framework 606:
IDENTITY, FIRSTNAME, LASTNAME, EMAIL, MANAGEDBY, BUNIT, COUNTRY, STATE, CITY, ACTIVE, CONTRACT, HIGHPROFILE, INSIDERRISK, ENVIRONMENT, PRIVILEGE, PRIVILEGEMAP, TOTAL_RISKSCORE, PRIORITY, PRIORITY_SCORE, COMMENT.
   IDENTITY: The identity field will be composed of the root level tree and preceding identities that fall under the root tree
      array
   FIRSTNAME: First name of the user
      string
   LASTNAME: Last name of the user
      string
   EMAIL: Email associated with the identity
      string
   MANAGEDBY: Point of contact or direct manager
      string
   BUNIT: Business unit this identity is part of or used in
      string
   COUNTRY: Country the identity operates out of
      string
   STATE: State the identity operates out of
      string
   CITY: City the identity operates out of (null if remote)
      string
   ACTIVE: Terminated/active employee
      boolean
   CONTRACT: Contracted employee/external user
      boolean
   HIGHPROFILE: Executive level employees—director and above
      boolean
   INSIDERRISK: Is there insider threat risk involved with this identity
      integer
   ENVIRONMENT: Associated environment for identity
      string
   PRIVILEGE: Privileges associated with an identity
      array
   PRIVILEGEMAP: Privileges mapped to environment associated with identity
      array
   TOTAL_RISKSCORE: Score associated with the prioritization algorithm
      integer
   PRIORITY: Qualitative risk score associated with risk score
      string
   PRIORITY_SCORE: Quantitative scalar score associated with priority
      integer
   COMMENT: Additional information
      string

The asset framework 608 holds information related to various entities in the environment and deployments throughout the database system 104. Asset data can be gathered from several sources of truth. Assets include, but are not limited to, applications, endpoints, nodes, workloads, ip addresses, and domains. Assets are often not performing actions themselves, however, they can be a source of attack and also a destination of attack. This is also referred to as a risk object. The prioritization of assets is factored in at both the source and destination hierarchy. Examples of entity data sources include: cloud resources, storage, applications, features, and services.

The following illustrates an example of a skeleton of the asset framework 608:
UID, OWNER, TYPE, SUB_TYPE, ENVIRONMENT, WORKLOAD_PRIORITY, DATA_TYPE, IS_EXPECTED, AGENT_ENABLED, CVSS_SCORE, PUBLIC_EXPOSURE, RISK_SCORE, PRIORITY, PRIORITY_SCORE, PARAMETERS, COMMENT, SOURCE
   UID: The unique identifier of the asset
      string
   OWNER: Owner or responsible party of the asset
      string
   TYPE: Type of asset being assessed (compute, policy, ip/subnet, secret, etc.)
      string
   SUB_TYPE: More granular specification of type (Type of compute (pod, container, ec2, vm, on-premise, domain controller), type of policy, type of ip/subnet (production ip range, VPN IP address), etc.)
      string
   ENVIRONMENT: The environment where this asset resides
      string
   WORKLOAD_PRIORITY: Role of the asset and what the asset supports in the ecosystem
      string
   DATA_TYPE: Type of data that the asset handles and processes (public/internal-only/sensitive/restricted)
      string
   IS_EXPECTED: Is this an expected/known asset in the ecosystem?
      boolean
   AGENT_ENABLED: Does this asset have an on-system security monitor agent if applicable?
      boolean
   CVSS_SCORE: What is the score of the most severe vulnerability on this asset?
      integer
   PUBLIC_EXPOSURE: Is this asset public facing? Public facing could mean public physically or public over the network
      boolean
   RISK_SCORE: Score associated with the prioritization algorithm of the asset
      integer
   PRIORITY: Qualitative score associated with the risk score
      string
   PRIORITY_SCORE: Quantitative scalar score associated with priority
      integer
   PARAMETERS: Additional asset information to provide context (all IP addresses associated with a system, mac addresses, etc.)
      array
   COMMENT: manual addition of information or notes
      string
   SOURCE: source of where the asset data comes from (e.g., AWS, GCP, ServiceNow)
      string

The identity prioritization algorithm 604 is used to generate scalar scores for the priority of an entity. Criticality of an entity is binned into 4 buckets: Low, Medium, High, and Critical. Each of these buckets has a scalar score associated and can be used to appropriately accumulate risk per the risk based alerting algorithm.

In one example, the identity prioritization algorithm 604 first computes a total risk score based on the following parameter scalar values: the sum of the identity's risk score from the different environments with respect the maximum risk score: sum_risk_score=Σ(privilege*environment scalars), the probability of being an inactive employee if terminated, the probability of being a contract employee if on a contract, the probability of being a high profile employee if an executive. An example algorithm of the identity prioritization algorithm 604 is:

$$IDENTITY\_PRIORITIZATION \_SCORE = ( SUM\_RISK \_SCORE / MAX\_RISK \_SCORE ) * ( 1 + ( INACTIVE\_COUNT / TOTAL\_COUNT ) * ACTIVE ) * ( 1 + ( CONTRACT\_COUNT / TOTAL\_COUNT ) * CONTRACT ) * ( 1 + ( HIGHPROFILE\_COUNT / TOTAL\_COUNT ) * HIGHPROFILE )$$

The identity prioritization algorithm 604 then uses the total risk scores to calculate the Interquartile Range (IQR), using a python UDF, to dynamically set the threshold for identity priority within the population. The thresholds determine which priority bucket the identity will fall into. IQR measures the spread of the middle half of the population, which translates to the medium priority. Since the total risk score distribution is right skewed, the quantity of total risk scores below the IQR are used to determine the left and right boundaries for low and high priorities. The remaining total risk scores are bucketed into the critical priority.

The asset prioritization algorithm 610 computes an asset risk score based on prioritization features. An example algorithm of the asset prioritization algorithm 610 is:

$$ASSET\_PRIORITIZATION \_SCORE = ENVIRONMENT\_SCALAR * WORKLOAD\_SCALAR * DATA\_TYPE \_SCALAR * VULNERABILITIES\_SCALAR * ( 1 + ( NOT\_EXPECTED \_COUNT / TOTAL\_COUNT ) * IS\_EXPECTED \_SCALAR ) * ( 1 + ( NO\_AGENT \_ENABLED \_COUNT / TOTAL\_COUNT ) * EDR\_SCALAR ) * ( 1 + ( PUBLIC\_FACING \_COUNT / TOTAL\_CONT ) * PUBLIC\_EXPOSURE \_SCALAR )$$

FIG. 7 is a block diagram illustrating a detection likelihood component 504 in accordance with one example embodiment. The detection likelihood component 504 includes a detection likelihood framework 702 and a detection likelihood algorithm 704.

The detection likelihood framework 702 identifies values and corresponding scalar values for parameters (e.g., knowledge, attack vector, attack complexity/TTPs (tactics, techniques, and procedures), mitigating controls).

The detection likelihood algorithm 704 calculates a likelihood score based on the values from the detection likelihood framework 702. An example algorithm of the detection likelihood algorithm 704 is:

$$LIKELIHOOD = KNOWLEDGE * ATTACK\_VECTOR * ATTACK\_COMPLEXITY / TTPS * MITIGATING\_CONTROLS$$

FIG. 8 is a block diagram illustrating the risk-based alerting component 506 in accordance with one example embodiment. The risk-based alerting component 506 includes a risk-based algorithm 802 and a risk-based alerting mechanism 804. The risk-based algorithm 802 calculates a risk score associated with each detection that triggers for a specific entity and can be followed with this algorithm:

RISK_SCORE=RISK_FACTOR*DETECTION_LIKELIHOOD

In another example, the above algorithm can be enhanced as follows:

RISK_SCORE=RISK_FACTOR*RISK_OBJECT*DETECTION_LIKELIHOOD*DETECTION_FIDELITY*SEQUENCING(TI[Threat Intelligence])*COMMUNICATION_CYCLES

The risk-based algorithm 802 includes the following algorithm features:
Risk Score: Risk score accumulated on an entity for a detection
Risk Factor: Entity prioritization risk score
Risk Object: Entity prioritization risk score
Detection Likelihood: Score associated with detection probability.
Detection Fidelity: How confident the detection is that its producing a true positive (TP)
Sequencing: Threat Intelligence Kill Chain multiplier or sequential kill chain attacks

The risk-based alerting mechanism 804 utilizes the above building blocks and accumulates risk score for each entity for a set amount of time (e.g., 24 hours), for each detection that is triggered for said entity. If the aggregated risk score is greater than the risk threshold then an alert is triggered. This risk aggregation will be stored in a risk data model, and risk scoring will be reset upon triaging of alerting.

In one example, the risk-based alerting mechanism 804 operates as follows: every alert is a risk builder and in events of atomic detection, the detection threshold will surpass immediately off the trigger of one atomic detection (e.g., critical alerts=100). Otherwise, the risk-based alerting mechanism 804 looks for any breach of risk threshold. The risk-based alerting mechanism 804 can run every 15 minutes and will take the sum of the risk scores over the risk data model time period and trigger an event.

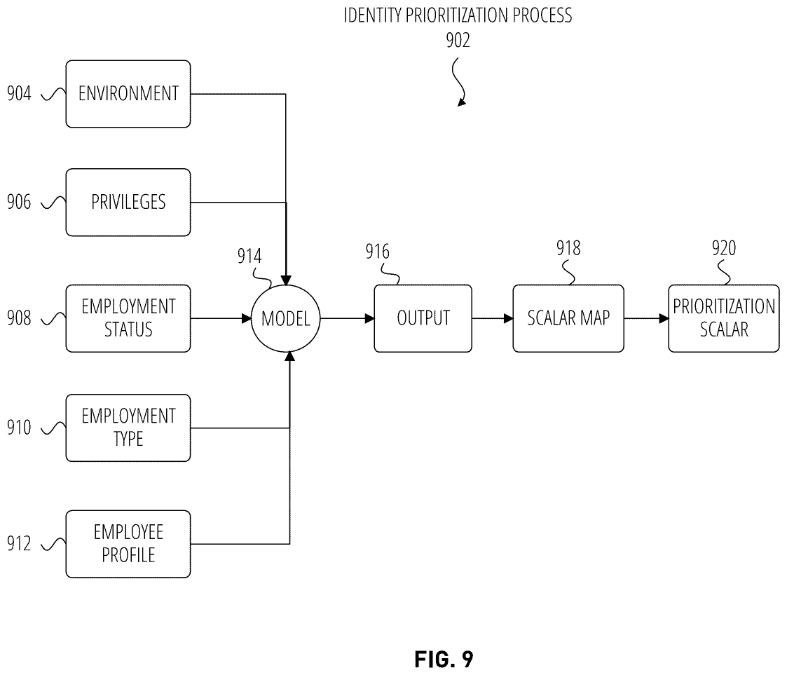

FIG. 9 is a process diagram illustrating an identity prioritization process 902 in accordance with one example embodiment. The identity prioritization process 902 includes the following parameters: environment 904, privileges 906, employment status 908, employment type 910, and employee profile 912. The environment 904 identifies the environment in which the user has access to the database system 104. The privileges 906 identifies privileges (e.g., unknown/no access, read only, modify, administrator) within the environment. The employment status 908 identifies employment status (e.g., active, terminated/disabled). The employment type 910 identifies employment type (e.g., full time employee, contract). The employee profile 912 identifies employee profile (e.g., non-executive level employees, executive level employees). The model 914 provides a model for the parameters. The output 916 provides qualitative scores and boolean values to the scalar map 918. The scalar map 918 maps the values from the output 916 to a quantitative scalar score: prioritization scalar 920.

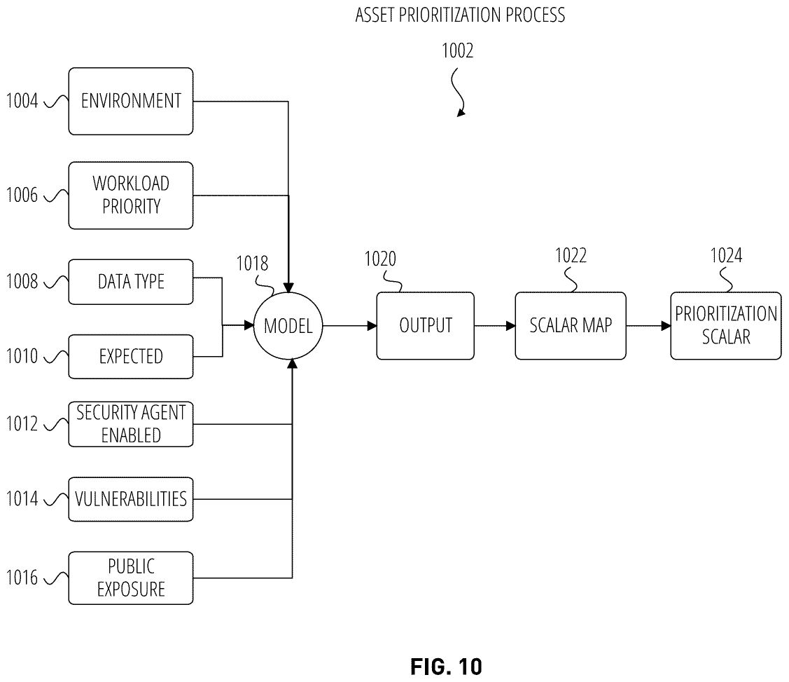

FIG. 10 is a process diagram illustrating an asset prioritization process 1002 in accordance with one example embodiment. The asset prioritization process 1002 includes the following parameters: an environment 1004 (e.g., sandbox, corporate, production), a workload priority 1006 (e.g., consumable, endpoint, corporate hardware, corporate system, production system), a data type 1008 (e.g., public, internal, sensitive, restricted), an expected parameter 1010 (e.g., expected, not expected), a security agent enabled setting 1012 (e.g., enabled, not enabled), vulnerabilities 1014 scores, a public exposure 1016 (e.g., yes, no). The model 1018 provides a model for the parameters. An output 1020 provides qualitative scores. A scalar map 1022 maps values from the output 1020 to a quantitative scalar score: a prioritization scalar 1024.

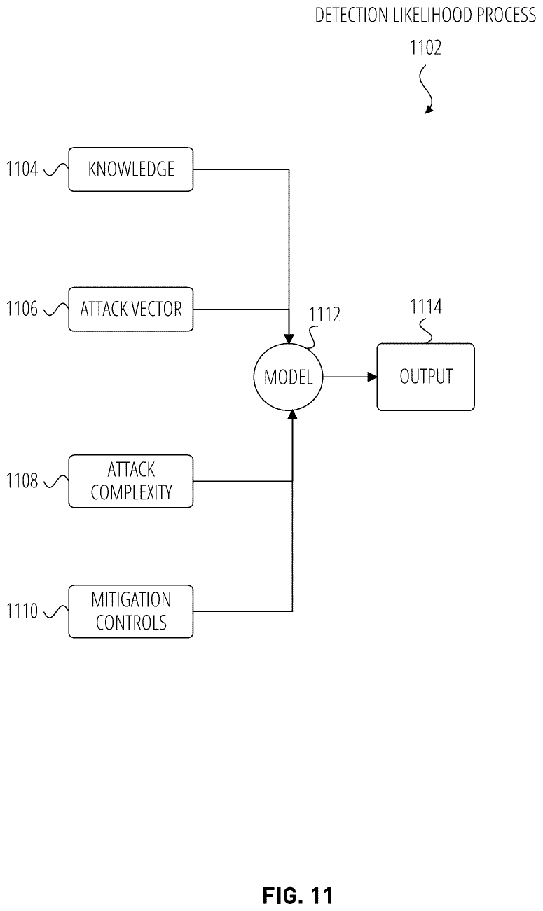

FIG. 11 is a process diagram illustrating a detection likelihood process 1102 in accordance with one example embodiment. The detection likelihood process 1102 includes the following parameters: knowledge 1104 (e.g., how well known is the system), attack vector 1106 (e.g., how and where is exploitation possible?), attack complexity 1108 (e.g., how difficult would it be to exploit the system), mitigation controls 1110 (e.g., are risks mitigated by controls?). The model 1112 provides a model for the parameters. The output 1114 provides qualitative scores.

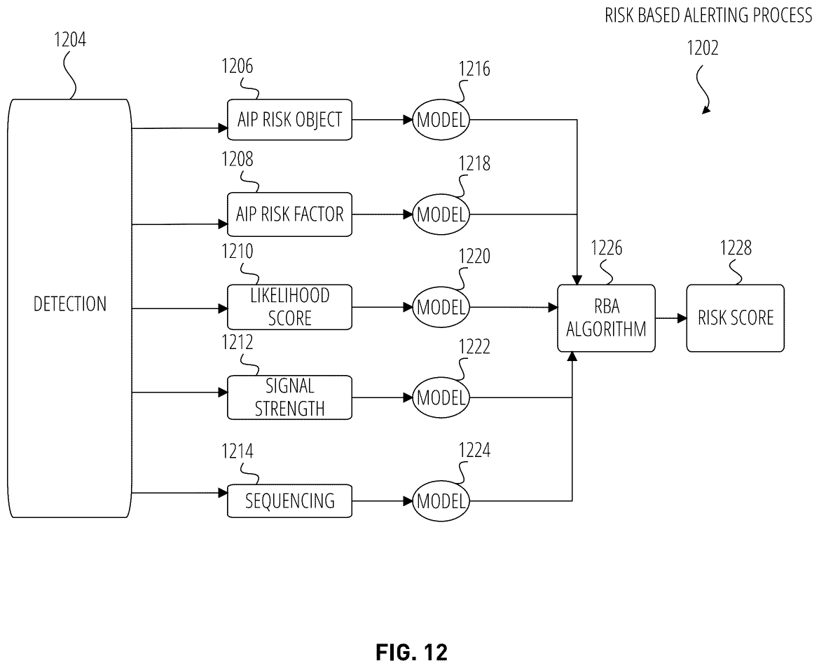

FIG. 12 is a process diagram illustrating a risk-based alerting process 1202 in accordance with one example embodiment. The detection 1204 identifies an event. The event is associated with an AIP risk object 1206 (e.g., asset prioritization score), an AIP risk factor 1208 (e.g., identity prioritization score), a likelihood score 1210 (e.g., score associated with detection likelihood), a signal strength 1212 (e.g., how confident the detection is that its producing a TP), a sequencing 1214 (e.g., threat Intelligence Kill Chain multiplier or sequential kill chain attacks). Each feature is fed into their corresponding model (e.g., model 1216, model 1218, model 1220, model 1222, model 1224). The output of the models is fed into the RBA algorithm 1226 that generates the risk score 1228.

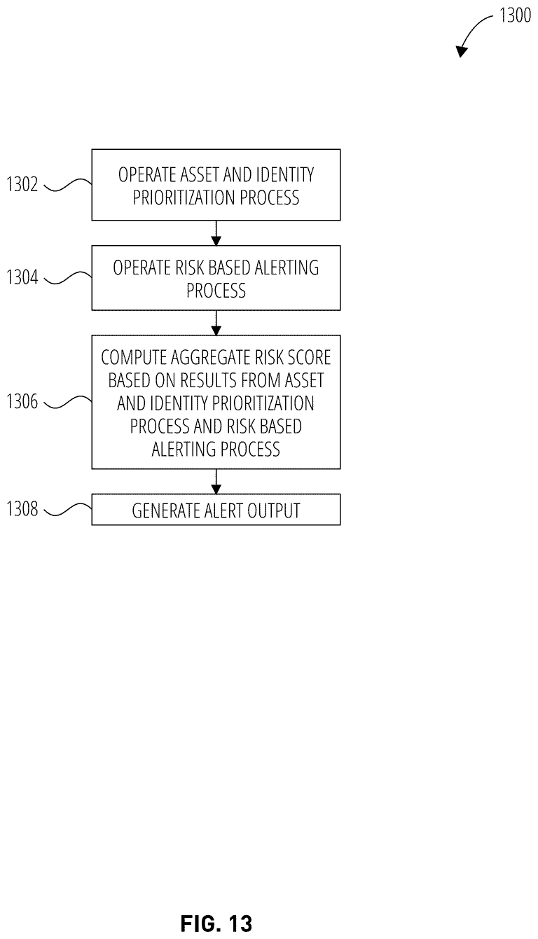

FIG. 13 illustrates an example method 1300 for computing an aggregate risk score. Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implements the method 1300 may perform functions at substantially the same time or in a specific sequence.

According to some examples, the method includes operating asset and identity prioritization process at block 1302.

According to some examples, the method includes operating risk based alerting process at block 1304.

According to some examples, the method includes computing aggregate risk score based on results from asset and identity prioritization process and risk based alerting process at block 1306.

According to some examples, the method includes generating alert output at block 1308.

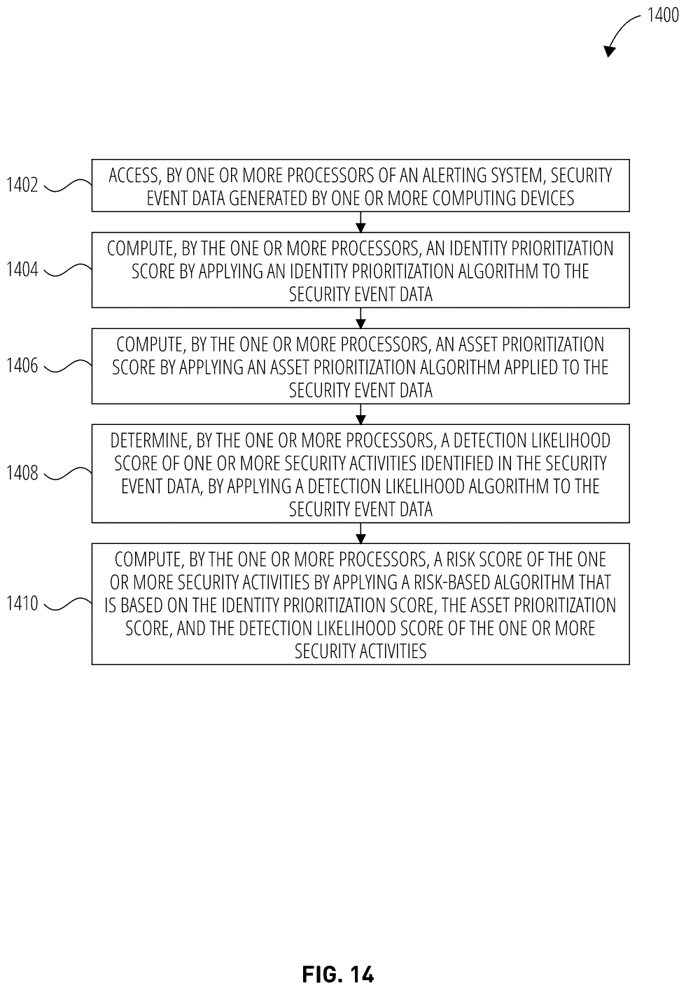

FIG. 14 illustrates a routine 1400 in accordance with one example embodiment. In block 1402, routine 1400 accesses, by one or more processors of an alerting system, security event data generated by one or more computing devices. In block 1404, routine 1400 computes, by the one or more processors, an identity prioritization score by applying an identity prioritization algorithm to the security event data. In block 1406, routine 1400 computes, by the one or more processors, an asset prioritization score by applying an asset prioritization algorithm applied to the security event data. In block 1408, routine 1400 determines, by the one or more processors, a detection likelihood score of one or more security activities identified in the security event data, by applying a detection likelihood algorithm to the security event data. In block 1410, routine 1400 computes, by the one or more processors, a risk score of the one or more security activities by applying a risk-based algorithm that is based on the identity prioritization score, the asset prioritization score, and the detection likelihood score of the one or more security activities.

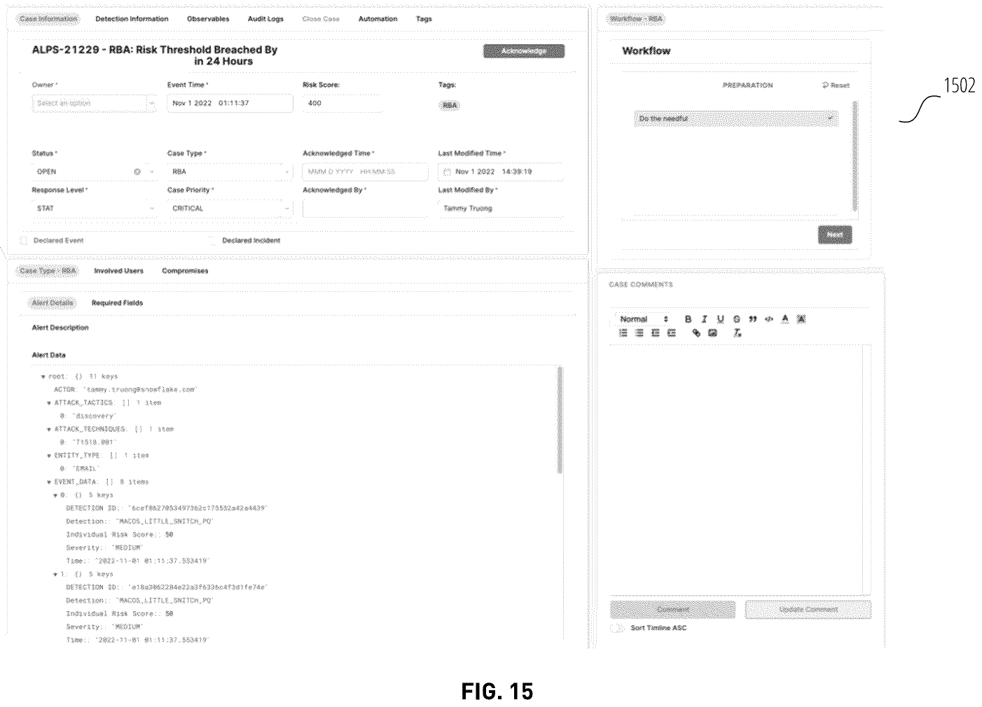

FIG. 15 is an alerting graphical user interface in accordance with one example embodiment.

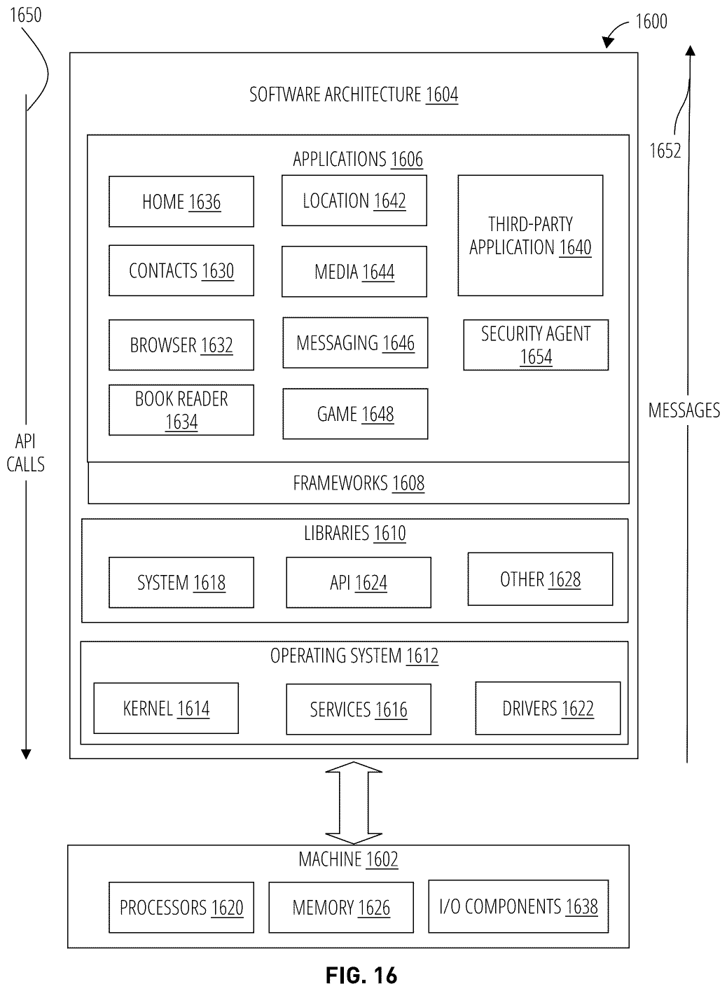

FIG. 16 is a block diagram 1600 illustrating a software architecture 1604, which can be installed on any one or more of the devices described herein. The software architecture 1604 is supported by hardware such as a machine 1602 that includes Processors 1620, memory 1626, and I/O Components 1638. In this example, the software architecture 1604 can be conceptualized as a stack of layers, where each layer provides a particular functionality. The software architecture 1604 includes layers such as an operating system 1612, libraries 1610, frameworks 1608, and applications 1606. Operationally, the applications 1606 invoke API calls 1650 through the software stack and receive messages 1652 in response to the API calls 1650.

The operating system 1612 manages hardware resources and provides common services. The operating system 1612 includes, for example, a kernel 1614, services 1616, and drivers 1622. The kernel 1614 acts as an abstraction layer between the hardware and the other software layers. For example, the kernel 1614 provides memory management, Processor management (e.g., scheduling), Component management, networking, and security settings, among other functionality. The services 1616 can provide other common services for the other software layers. The drivers 1622 are responsible for controlling or interfacing with the underlying hardware. For instance, the drivers 1622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1610 provide a low-level common infrastructure used by the applications 1606. The libraries 1610 can include system libraries 1618 (e.g., C standard library) that provide functions such as memory allocation functions, string manipulation functions, mathematic functions, and the like. In addition, the libraries 1610 can include API libraries 1624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1610 can also include a wide variety of other libraries 1628 to provide many other APIs to the applications 1606.

The frameworks 1608 provide a high-level common infrastructure that is used by the applications 1606. For example, the frameworks 1608 provide various graphical user interface (GUI) functions, high-level resource management, and high-level location services. The frameworks 1608 can provide a broad spectrum of other APIs that can be used by the applications 1606, some of which may be specific to a particular operating system or platform.

In an example embodiment, the applications 1606 may include a home application 1636, a contacts application 1630, a browser application 1632, a book reader application 1634, a location application 1642, a media application 1644, a messaging application 1646, a game application 1648, a security agent 1654, and a broad assortment of other applications such as a third-party application 1640. The applications 1606 are programs that execute functions defined in the programs. Various programming languages can be employed to create one or more of the applications 1606, structured in a variety of manners, such as object-oriented programming languages (e.g., Objective-C, Java, or C++) or procedural programming languages (e.g., C or assembly language). In a specific example, the third-party application 1640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1640 can invoke the API calls 1650 provided by the operating system 1612 to facilitate functionality described herein.

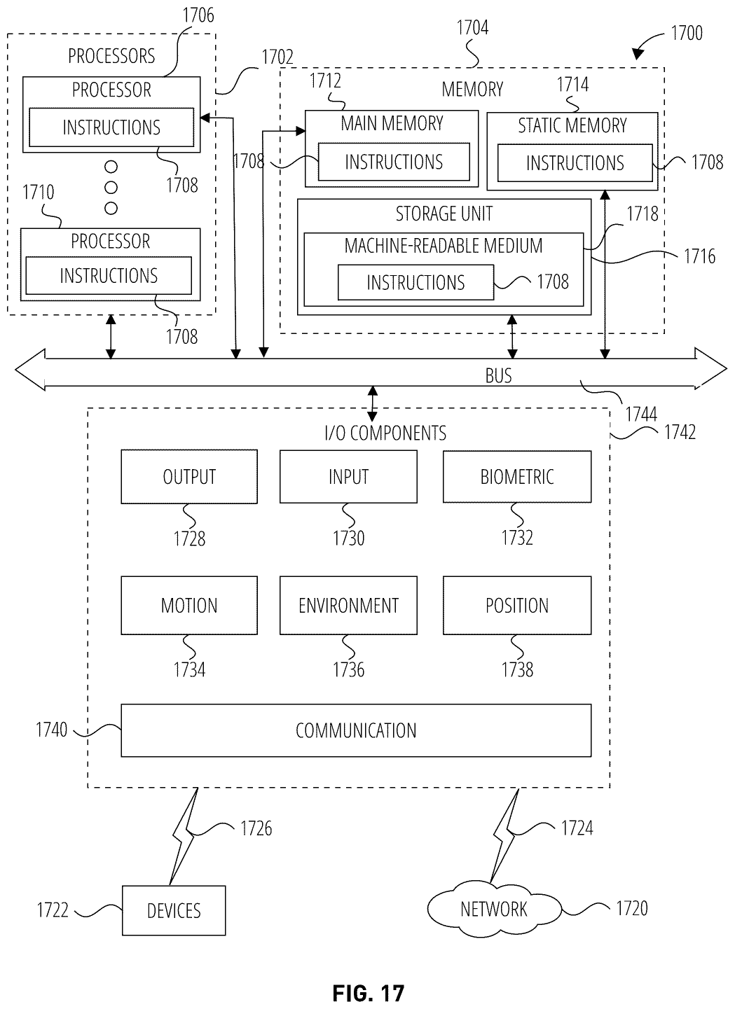

FIG. 17 is a diagrammatic representation of the machine 1700 within which instructions 1708 (e.g., software, a program, an application, an applet, an app, or other executable code) for causing the machine 1700 to perform any one or more of the methodologies discussed herein may be executed. For example, the instructions 1708 may cause the machine 1700 to execute any one or more of the methods described herein. The instructions 1708 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1708, sequentially or otherwise, that specify actions to be taken by the machine 1700. Further, while only a single machine 1700 is illustrated, the term “machine” shall also be taken to include a collection of machines that individually or jointly execute the instructions 1708 to perform any one or more of the methodologies discussed herein.

The machine 1700 may include Processors 1702, memory 1704, and I/O Components 1742, which may be configured to communicate with each other via a bus 1744. In an example embodiment, the Processors 1702 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1706 and a Processor 1710 that execute the instructions 1708. The term “Processor” is intended to include multi-core Processors that may comprise two or more independent Processors (sometimes referred to as “cores”) that may execute instructions contemporaneously. Although FIG. 17 shows multiple Processors 1702, the machine 1700 may include a single Processor with a single core, a single Processor with multiple cores (e.g., a multi-core Processor), multiple Processors with a single core, multiple Processors with multiples cores, or any combination thereof.

The memory 1704 includes a main memory 1712, a static memory 1714, and a storage unit 1716, both accessible to the Processors 1702 via the bus 1744. The main memory 1704, the static memory 1714, and storage unit 1716 store the instructions 1708 embodying any one or more of the methodologies or functions described herein. The instructions 1708 may also reside, completely or partially, within the main memory 1712, within the static memory 1714, within machine-readable medium 1718 within the storage unit 1716, within at least one of the Processors 1702 (e.g., within the Processor's cache memory), or any suitable combination thereof, during execution thereof by the machine 1700.

The I/O Components 1742 may include a wide variety of Components to receive input, provide output, produce output, transmit information, exchange information, capture measurements, and so on. The specific I/O Components 1742 that are included in a particular machine will depend on the type of machine. For example, portable machines such as mobile phones may include a touch input device or other such input mechanisms, while a headless server machine will likely not include such a touch input device. It will be appreciated that the I/O Components 1742 may include many other Components that are not shown in FIG. 17. In various example embodiments, the I/O Components 1742 may include output Components 1728 and input Components 1730. The output Components 1728 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1730 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1742 may include biometric Components 1732, motion Components 1734, environmental Components 1736, or position Components 1738, among a wide array of other Components. For example, the biometric Components 1732 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1734 include acceleration sensor Components (e.g., accelerometer), gravitation sensor Components, rotation sensor Components (e.g., gyroscope), and so forth. The environmental Components 1736 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1738 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1742 further include communication Components 1740 operable to couple the machine 1700 to a network 1720 or devices 1722 via a coupling 1724 and a coupling 1726, respectively. For example, the communication Components 1740 may include a network interface Component or another suitable device to interface with the network 1720. In further examples, the communication Components 1740 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1722 may be another machine or any of a wide variety of peripheral devices (e.g., a peripheral device coupled via a USB).

Moreover, the communication Components 1740 may detect identifiers or include Components operable to detect identifiers. For example, the communication Components 1740 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1740, such as location via Internet Protocol (IP) geolocation, location via Wi-Fi® signal triangulation, location via detecting an NFC beacon signal that may indicate a particular location, and so forth.

The various memories (e.g., memory 1704, main memory 1712, static memory 1714, and/or memory of the Processors 1702) and/or storage unit 1716 may store one or more sets of instructions and data structures (e.g., software) embodying or used by any one or more of the methodologies or functions described herein. These instructions (e.g., the instructions 1708), when executed by Processors 1702, cause various operations to implement the disclosed embodiments.

The instructions 1708 may be transmitted or received over the network 1720, using a transmission medium, via a network interface device (e.g., a network interface Component included in the communication Components 1740) and using any one of a number of well-known transfer protocols (e.g., hypertext transfer protocol (HTTP)). Similarly, the instructions 1708 may be transmitted or received using a transmission medium via the coupling 1726 (e.g., a peer-to-peer coupling) to the devices 1722.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### Examples

Some embodiments are described as numbered examples (Example 1, 2, 3, etc.). These are provided as examples only and do not limit the technology disclosed herein.
Example 1 is a computer-implemented method comprising: accessing, by one or more processors of an alerting system, security event data generated by one or more computing devices; computing, by the one or more processors, an identity prioritization score by applying an identity prioritization algorithm to the security event data; computing, by the one or more processors, an asset prioritization score by applying an asset prioritization algorithm applied to the security event data; determining, by the one or more processors, a detection likelihood score of one or more security activities identified in the security event data, by applying a detection likelihood algorithm to the security event data; and computing, by the one or more processors, a risk score of the one or more security activities by applying a risk-based algorithm that is based on the identity prioritization score, the asset prioritization score, and the detection likelihood score of the one or more security activities.
In Example 2, the subject matter of Example 1 includes, generating an alert output based on the risk score; and communicating the alert output to one or more devices of Security Operation Centers (SOC) and an Incident Response (IR) team, the one or more devices configured to adjust an operation of the one or more computing devices based on the risk score.
In Example 3, the subject matter of Examples 1-2 includes, wherein the identity prioritization algorithm is configured to identify identity prioritization parameters and compute an identity priority scalar score based on values of the identity prioritization parameters and an identity scalar map.
In Example 4, the subject matter of Example 3 includes, wherein the identity prioritization parameters comprise at least one of: a computing environment parameter, a privilege within the computing environment parameter, an employment status parameter, an employment type parameter, or an employee profile parameter.
In Example 5, the subject matter of Example 4 includes, wherein the identity prioritization algorithm is configured to calculate a total identity risk score based on a sum of an identity risk score from different environments, a probability of being an inactive employee, and a probability of being a contract employee, a probability of being a high profile employee.
In Example 6, the subject matter of Example 5 includes, wherein the identity prioritization algorithm is configured to calculate interquartile ranges for the total identity risk score to dynamically set a threshold for identity priority within a population, and to identity the identity priority scalar score based on the total identity risk score relative to the interquartile ranges.
In Example 7, the subject matter of Examples 1-6 includes, wherein the asset prioritization algorithm is configured to identify asset prioritization parameters and compute an asset priority scalar score based on values of the asset prioritization parameters and an asset scalar map.
In Example 8, the subject matter of Example 7 includes, wherein the asset prioritization parameters comprise at least one of: an asset environment parameter, a workload priority parameter, a data type parameter, an asset expectation parameter, an asset security agent parameter, vulnerabilities parameter, public facing parameter, maintenance parameter, asset granting system parameter, lateral movement parameter, or vertical movement parameter.
In Example 9, the subject matter of Example 8 includes, wherein the asset priority scalar score is based on a product of quantitative values of the asset prioritization parameters.
In Example 10, the subject matter of Examples 1-9 includes, wherein the detection likelihood score is based on a likelihood score, wherein the likelihood score includes a calculation of likelihood parameters scores.
In Example 11, the subject matter of Examples 1-10 includes, wherein the risk score of the one or more security activities is a product of the identity prioritization score, the asset prioritization score and the detection likelihood score.
In Example 12, the subject matter of Examples 1-11 includes, wherein the security event data is based on network traffic data that identify a combination of source IP addresses, destination IP addresses, ports, protocols, payloads, timestamps, and intervals.
Example 13 is a computing apparatus comprising: a processor; and a memory storing instructions that, when executed by the processor, configure the apparatus to: access, by one or more processors of the computing apparatus, security event data generated by one or more computing devices; compute, by the one or more processors, an identity prioritization score by applying an identity prioritization algorithm to the security event data; compute, by the one or more processors, an asset prioritization score by applying an asset prioritization algorithm applied to the security event data; determine, by the one or more processors, a detection likelihood score of one or more security activities identified in the security event data, by applying a detection likelihood algorithm to the security event data; and compute, by the one or more processors, a risk score of the one or more security activities by applying a risk-based algorithm that is based on the identity prioritization score, the asset prioritization score, and the detection likelihood score of the one or more security activities.
In Example 14, the subject matter of Example 13 includes, wherein the instructions further configure the apparatus to: generate an alert output based on the risk score; and communicate the alert output to one or more devices of Security Operation Centers (SOC) and an Incident Response (IR) team, the one or more devices configured to adjust an operation of the one or more computing devices based on the risk score.
In Example 15, the subject matter of Examples 13-14 includes, wherein the identity prioritization algorithm is configured to identify identity prioritization parameters and compute an identity priority scalar score based on values of the identity prioritization parameters and an identity scalar map.
In Example 16, the subject matter of Examples 13-15 includes, wherein the asset prioritization algorithm is configured to identify asset prioritization parameters and compute an asset priority scalar score based on values of the asset prioritization parameters and an asset scalar map.
In Example 17, the subject matter of Examples 13-16 includes, wherein the detection likelihood score is based on a likelihood score, wherein the likelihood score includes a calculation of the likelihood parameters scores.
In Example 18, the subject matter of Examples 13-17 includes, wherein the risk score of the one or more security activities is a product of the identity prioritization score, the asset prioritization score, and the detection likelihood score.
In Example 19, the subject matter of Examples 13-18 includes, wherein the security event data is based on network traffic data that identify a combination of source IP addresses, destination IP addresses, ports, protocols, payloads, timestamps, and intervals.
Example 20 is a non-transitory computer-readable storage medium, the computer-readable storage medium including instructions that when executed by a computer, cause the computer to: access, by one or more processors of the computer, security event data generated by one or more computing devices; compute, by the one or more processors, an identity prioritization score by applying an identity prioritization algorithm to the security event data; compute, by the one or more processors, an asset prioritization score by applying an asset prioritization algorithm applied to the security event data; determine, by the one or more processors, a detection likelihood score of one or more security activities identified in the security event data, by applying a detection likelihood algorithm to the security event data; and compute, by the one or more processors, a risk score of the one or more security activities by applying a risk-based algorithm that is based on the identity prioritization score, the asset prioritization score, and the detection likelihood score of the one or more security activities.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

What is claimed is:

1. A computer-implemented method comprising:
accessing, by one or more processors of an alerting system, security event data generated by one or more computing devices;
computing, by the one or more processors, an identity prioritization score by applying an identity prioritization algorithm to the security event data;
computing, by the one or more processors, an asset prioritization score by applying an asset prioritization algorithm applied to the security event data;
determining, by the one or more processors, a detection likelihood score of one or more security activities identified in the security event data, by applying a detection likelihood algorithm to the security event data; and
computing, by the one or more processors, a risk score of the one or more security activities by applying a risk-based algorithm that is based on the identity prioritization score, the asset prioritization score, and the detection likelihood score of the one or more security activities.

2. The computer-implemented method of claim 1, further comprising:
generating an alert output based on the risk score; and
communicating the alert output to one or more devices of Security Operation Centers (SOC) and an Incident Response (IR) team, the one or more devices configured to adjust an operation of the one or more computing devices based on the risk score.

3. The computer-implemented method of claim 1, wherein the identity prioritization algorithm is configured to identify identity prioritization parameters and compute an identity priority scalar score based on values of the identity prioritization parameters and an identity scalar map.

4. The computer-implemented method of claim 3, wherein the identity prioritization parameters comprise at least one of: a computing environment parameter, a privilege within the computing environment parameter, an employment status parameter, an employment type parameter, or an employee profile parameter.

5. The computer-implemented method of claim 4, wherein the identity prioritization algorithm is configured to calculate a total identity risk score based on a sum of an identity risk score from different environments, a probability of being an inactive employee, and a probability of being a contract employee, a probability of being a high profile employee.

6. The computer-implemented method of claim 5, wherein the identity prioritization algorithm is configured to calculate interquartile ranges for the total identity risk score to dynamically set a threshold for identity priority within a population, and to identity the identity priority scalar score based on the total identity risk score relative to the interquartile ranges.

7. The computer-implemented method of claim 1, wherein the asset prioritization algorithm is configured to identify asset prioritization parameters and compute an asset priority scalar score based on values of the asset prioritization parameters and an asset scalar map.

8. The computer-implemented method of claim 7, wherein the asset prioritization parameters comprise at least one of: an asset environment parameter, a workload priority parameter, a data type parameter, an asset expectation parameter, an asset security agent parameter, vulnerabilities parameter, public facing parameter, maintenance parameter, asset granting system parameter, lateral movement parameter, or vertical movement parameter.

9. The computer-implemented method of claim 8, wherein the asset priority scalar score is based on a product of quantitative values of the asset prioritization parameters.

10. The computer-implemented method of claim 1, wherein the detection likelihood score is based on a likelihood score,
wherein the likelihood score includes a calculation of likelihood parameters scores.

11. The computer-implemented method of claim 1, wherein the risk score of the one or more security activities is a product of the identity prioritization score, the asset prioritization score and the detection likelihood score.

12. The computer-implemented method of claim 1, wherein the security event data is based on network traffic data that identify a combination of source IP addresses, destination IP addresses, ports, protocols, payloads, timestamps, and intervals.

13. A computing apparatus comprising:
a processor; and
a memory storing instructions that, when executed by the processor, configure the apparatus to:
access, by one or more processors of the computing apparatus, security event data generated by one or more computing devices;
compute, by the one or more processors, an identity prioritization score by applying an identity prioritization algorithm to the security event data;
compute, by the one or more processors, an asset prioritization score by applying an asset prioritization algorithm applied to the security event data;
determine, by the one or more processors, a detection likelihood score of one or more security activities identified in the security event data, by applying a detection likelihood algorithm to the security event data; and
compute, by the one or more processors, a risk score of the one or more security activities by applying a risk-based algorithm that is based on the identity prioritization score, the asset prioritization score, and the detection likelihood score of the one or more security activities.

14. The computing apparatus of claim 13, wherein the instructions further configure the apparatus to:
generate an alert output based on the risk score; and
communicate the alert output to one or more devices of Security Operation Centers (SOC) and an Incident Response (IR) team, the one or more devices configured to adjust an operation of the one or more computing devices based on the risk score.

15. The computing apparatus of claim 13, wherein the identity prioritization algorithm is configured to identify identity prioritization parameters and compute an identity priority scalar score based on values of the identity prioritization parameters and an identity scalar map.

16. The computing apparatus of claim 13, wherein the asset prioritization algorithm is configured to identify asset prioritization parameters and compute an asset priority scalar score based on values of the asset prioritization parameters and an asset scalar map.

17. The computing apparatus of claim 13, wherein the detection likelihood score is based on a likelihood score,
wherein the likelihood score includes a calculation of the likelihood parameters scores.

18. The computing apparatus of claim 13, wherein the risk score of the one or more security activities is a product of the identity prioritization score, the asset prioritization score, and the detection likelihood score.

19. The computing apparatus of claim 13, wherein the security event data is based on network traffic data that identify a combination of source IP addresses, destination IP addresses, ports, protocols, payloads, timestamps, and intervals.

20. A non-transitory computer-readable storage medium, the computer-readable storage medium including instructions that when executed by a computer, cause the computer to:
access, by one or more processors of the computer, security event data generated by one or more computing devices;
compute, by the one or more processors, an identity prioritization score by applying an identity prioritization algorithm to the security event data;
compute, by the one or more processors, an asset prioritization score by applying an asset prioritization algorithm applied to the security event data;
determine, by the one or more processors, a detection likelihood score of one or more security activities identified in the security event data, by applying a detection likelihood algorithm to the security event data; and
compute, by the one or more processors, a risk score of the one or more security activities by applying a risk-based algorithm that is based on the identity prioritization score, the asset prioritization score, and the detection likelihood score of the one or more security activities.
